(19) United States
(12) Patent Application Publication
(10) Pub. No.: US 2003/0007521 A1
(43) Pub. Date: Jan. 9, 2003

(54) System and method for measuring, tuning and locking laser wavelengths over a broadband range

(76) Inventor: Larry Shousan Yu, San Jose, CA (US)

Correspondence Address: CARR & FERRELL LLP, 2225 EAST BAYSHORE ROAD, SUITE 200, PALO ALTO, CA, 94303, US

(21) Appl. No.: 09/895,887

(22) Filed: Jun. 29, 2001

(51) Int. Cl. H01S 3/098; H01S 3/10; H01S 3/13; H01S 3/00

(52) U.S. Cl. 372/20; 372/38.01; 372/29.011

(57) ABSTRACT

Described is a system for measuring, tuning and locking wavelengths of lasers. The system comprises a laser diode that emits a front (or source) laser beam for modulating communication signals and a rear laser beam for sensing and locking the central wavelength of the source laser beam. The rear laser beam is split into a first and a second laser beams. A first adjustable wavelength filter receives the first laser beam at a first incident angle to generate a first reference laser beam, and a second wavelength filter receives the second laser beam at a second incident angle to generate a second reference laser beam. A first photo-detector generates a first reference photo-current in response to the first reference laser beam, and a second photo-detector generates a second reference photo-current in response to the second reference laser beam. The current difference between the first and second reference photo-currents is utilized to measure, tune and lock the central wavelength of the source laser beam. The overall bandwidth or tunable wavelength range within which the central wavelength of a source laser beam can be locked is determined by a filter's incident angle, reflection coefficient and thickness.

### BACKGROUND

1. Filed of the Invention

The invention relates generally to the field of laser optics, and more particularly, to a system and method for measuring, tuning and locking wavelengths of lasers.

2. Description of Prior Art

A desirable feature of a laser is its central wavelength stability over time and temperature. This feature is especially important for recently developed DWDM (Dense Wavelength Division Multiplex) fiber optic communication, where a spectral range is divided into multiple fine wavelength channels and each wavelength channel needs to be locked into and maintained at one of those wavelength channels specified by the ITU (International Telecommunication Union) grid standard. Any wavelength drift over time and temperature may cause problems, such as cross-talk noise, or even loss signal if the drift is too wide. Techniques for measuring, tuning and locking the central wavelength of a laser over a narrow spectral range (i.e., 4 nm) have been developed in the prior art. These conventional techniques involve measurements of the intensity of laser lights passing through narrow band filters. Because both the lasers to be measured and the filters used cover a narrow band wavelength range, the narrow band filters used in the conventional techniques are suited to tune and lock lasers over a very narrow spectral/wavelength range. A typical conventional narrow band wavelength locking mechanism involves the use of fixed narrow band filters and a point locking technique. Disadvantageously, the conventional techniques limit locking range to a small spectral/wavelength range.

Using conventional narrow band filters to measure, tune and lock the central wavelengths of lasers over a broad spectral/wavelength is problematic because the conventional narrow band filters may not have the bandwidth that is required to measure, tune and lock broadband tunable lasers.

Therefore, there is a need for improved system and method to measure, tune and lock central wavelengths of broadband tunable lasers over a wide spectral/wavelength range.

### SUMMARY

The present invention provides a novel system that is capable of accurately measuring, turning and locking central wavelengths of lasers over a broad wavelength range. Once tuned to a certain position, a central laser wavelength is then quickly locked into that position with excellent stability and minimum drift.

In a broad aspect, the system of the present invention comprises two photo-detectors that receive a first and a second reference laser beams, respectively. The output of a source laser beam is split into a first and a second laser beams. The first laser beam is delivered onto a first wavelength filter at a first incident angle to generate the first reference laser beam, and the second laser beam is delivered onto a second wavelength filter at a second incident angle to generate the second reference laser beam. The first photo-detector generates a first reference photo-current in response to the first reference laser beam, and the second photo-detector generates a second reference photo-current in response to the second reference laser beam. The difference between the first and second reference photo-currents is utilized to determine, tune and lock the central wavelength of the source laser beam.

The present invention also provides a corresponding method that is capable of accurately measuring, tuning and locking central wavelengths of lasers over a broad wavelength range.

### BRIEF DESCRIPTION OF THE DRAWINGS

The purpose and advantages of the present invention will be apparent to those skilled in the art from the following detailed description in conjunction with appended drawings, in which:

FIG. 1 shows a conventional etalon filter and its multiple light interference effect;

FIG. 2 shows filtering (or bandpass) characteristics of the etalon filter of FIG. 1;

FIG. 3 shows the effects on the filtering (or bandpass) characteristics of the etalon filter of FIG. 1 in response to adjustments of the reflection coefficient R of the etalon substrate 110 in FIG. 1;

FIG. 4A shows a laser wavelength locking system 400A, in accordance with a first embodiment of the present invention;

FIG. 4B shows a laser wavelength locking system 400B, in accordance with a second embodiment of the present invention;

FIG. 4C shows a laser wavelength locking system 400C, in accordance with a third embodiment of the present invention;

FIG. 4D shows a laser wavelength locking system 400D, in accordance with a fourth embodiment of the present invention;

FIG. 4E shows a laser wavelength locking system 400E, in accordance with a fifth embodiment of the present invention;

FIG. 5A shows an emitting side of the diode shown in FIGS. 4D-E in further detail;

FIG. 5B shows a section view of the diode of FIG. 5A, in accordance with one embodiment of the present invention;

FIG. 5C shows a section view of the diode of FIG. 5A, in accordance with another embodiment of the present invention;

FIG. 6 shows two spectral photo-current curves observed from the two photo-current detectors of FIGS. 4A-B and 4D-E;

FIG. 7 shows two spectral photo-current curves observed from the two photo-current detectors of FIGS. 4A-B and 4D-E with a much thinner thickness of the second filter or the second region than that of the first filter or the first region;

FIG. 8 shows two spectral photo-current curves observed from the two photo-current detectors of FIG. 4C;

FIG. 9 is a block diagram of an exemplary processing unit of FIGS. 4A-E in further detail, in accordance with the present invention;

FIG. 10 shows the look-up table of FIG. 9, in further detail; and

FIG. 11 shows a flowchart illustrating an exemplary process of measuring, tuning and locking the central wavelength of a laser, in accordance with the present invention.

### DETAILED DESCRIPTION OF THE INVENTION

The present invention comprises a novel system and a corresponding method for measuring, tuning and locking central wavelengths of lasers over a broad wavelength range. The following description is presented to enable any person skilled in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown,.but it to be accorded with the broadest scope consistent with the principles disclosed herein.

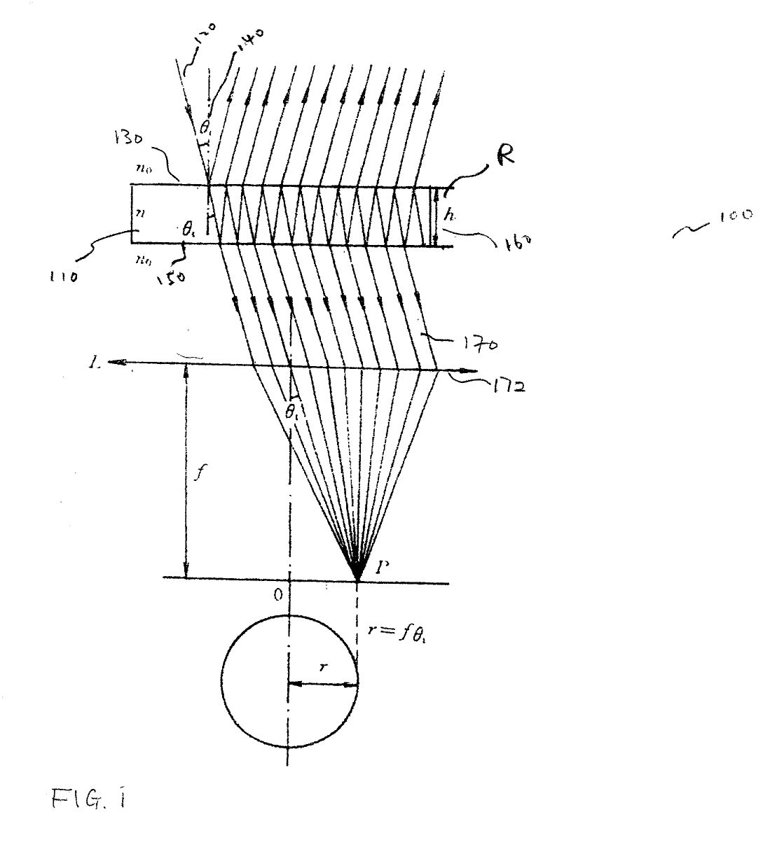

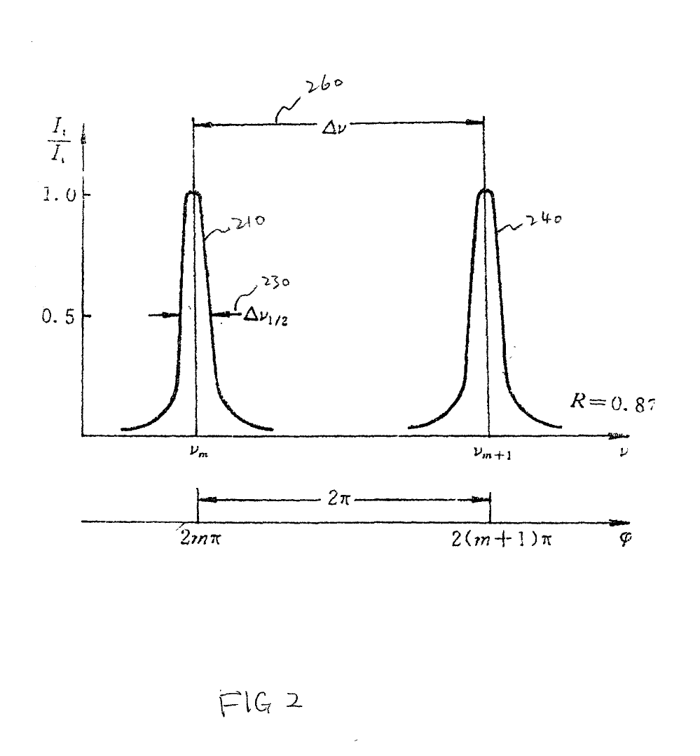

FIG. 1 shows a conventional etalon filter 100 and its multiple light interference effect. The etalon filter 100 comprises an etalon substrate 110 with a reflection coefficient R and a thickness h 160. A light 120 impinges on a top boundary 130 of the etalon substrate 110 at an incident angle θ 140, and a fraction of which is reflected from the top boundary 130 depending on the reflection coefficient R of the etalon substrate 110. The fraction of light 120 that is not reflected from the top boundary 130 passes through the top boundary 130 and impinges on a bottom boundary 150, where a fraction of light 120 is again reflected from the bottom boundary 150 depending on the R and h of the etalon substrate 110. The remaining fraction of the light 120, which passes through the bottom boundary 150 becoming output light 170 of the etalon substrate 110, impinges on a lens 172. The lens 172 focuses the output light 170 onto a focal position P, where a photo-detector (not shown) is able to convert the output light 170 to photo-current pulses as shown in FIG. 2. In FIG. 1, f stands for the focal length of the lens 172 and r for the radius distance of optical interference circular fringe pattern on the focal position P.

FIG. 2 shows two photo-current pulses as a function of the frequency (or wavelength) components in the light 120, which reflects the filtering (or bandpass) characteristics of the etalon substrate 110. The output light 170 from the etalon substrate 110 is wavelength dependent because of the optical property of the etalon substrate 110. Specifically, if the light 120 travels between the top boundary 130 and bottom boundary 150 is equal to an integral product of the distance λ/(2n) where n is the optical index of refraction, then the transmission of the light 120 through the etalon substrate 110 can approach maximum transmission efficiency. The distance λ/(2n) is the wavelength (λ) of the light 120 divided by two times of the index of refraction (n) of the volume between the top boundary 130 and bottom boundary 150. Therefore, the optimal condition for transmitting the light 120 having a wavelength λₘ through the etalon substrate 110 complies with the equation:

$${λ}_{m} = \frac{2 nh}{m} cos θ \qquad ( 1 )$$

where h is a separation distance 160 between the top boundary 130 and bottom boundary 150 of the etalon substrate 110 and m is the sequence or order number of optical interference circular fringe pattern on the focal position P as shown in FIG. 1. According to equation (1), the selected wavelength λₘ in the light 120 is varied by changing the incident angle θ 140 or separation distance h 160 of the etalon substrate 110.

In FIG. 2, a peak 210 is observed at frequency υₘ where υₘ=c/λₘ and c equals the speed of light. The peak 210 is characterized by a (Δυ)_{½} 230 (Half Width at Half Maximum in frequency domain) represented as:

$${( Δ υ )}_{1 / 2} = \frac{c ( 1 - R )}{2 π n h \sqrt{R} cos θ} \qquad ( 2 )$$

The next harmonic peak 240 is observed at frequency υₘ₊₁. A separation Δυₘ 260 between frequency υₘ and frequency υₘ₊₁ is represented as:

$$Δ {υ}_{m} = \frac{c}{{λ}_{m}^{2}} Δ {λ}_{m} \qquad ( 3 )$$

By using equations (1) and (3), the (Δυ)_{½} (Half Width at Half Maximum in frequency domain) can be converted into (Δλ)_{½} (Half Width at Half Maximum in wavelength domain) as follows:

$${( Δ {λ}_{m} )}_{1 / 2} = \frac{2 ( 1 - R ) nh cos θ}{{m}^{2} π \sqrt{R}} \qquad ( 4 )$$

The equations (2) and (4) illustrate that (Δυ)_{½} is proportional to (Δλ)_{½}, which in turn is a function of three parameters: the reflection coefficient, R, and the thickness, h, of the etalon substrate 110; and the incident angle θ 140 of the light 120. For example, the (Δυ)_{½} 230 can be increased by reducing the reflection coefficient R. Also, the (Δυ)_{½} 230 can be adjusted by changing the incident angle θ 140 or the separation distance h 160. The (Δυ)_{½} 230 can be deemed as the bandpass width (or region) of the etalon filter 100 of FIG. 1.

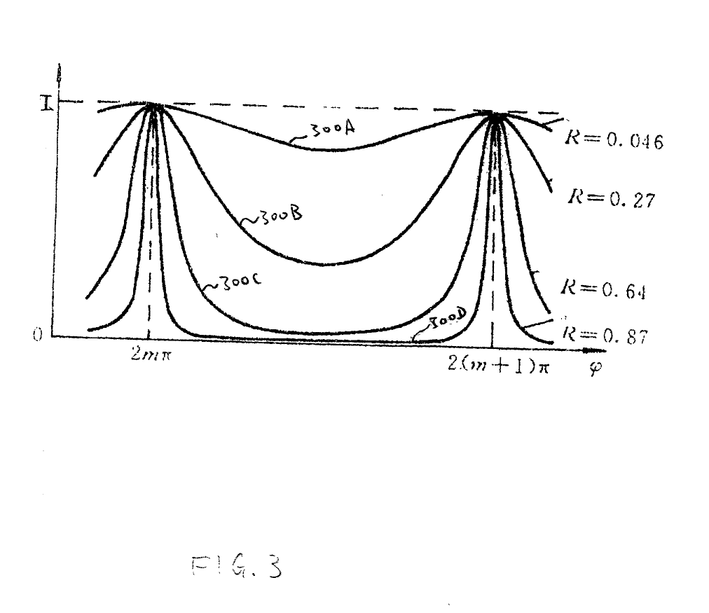

FIG. 3 shows the effects on the filtering (or bandpass) characteristics of the etalon filter 100 in response to adjustments of the reflection coefficient R of the etalon substrate 110. Specifically, in response to the adjustments of the reflection coefficient R of the etalon substrate 110, the two spectral photo-current pulses of FIG. 2 change their shapes accordingly. As shown in FIG. 3, there exist four different current intensity profiles 300A-D as a function of frequency (or wavelength) corresponding to four different reflection coefficients. The current profiles 300A, 300B, 300C, and 300D correspond to four reflection coefficients with values of 0.046, 0.27, 0.64, and 0.87, respectively. FIG. 3 indicates that bandpass width of (Δυ)_{½} is inversely proportional to the refection coefficient R of the etalon substrate 110. The present invention creatively selects (or sets) three parameters, i.e., the reflection coefficient R and thickness of an etalon filter, and the incident angle θ of a source laser light, to produce filters having a broadband range that is required to measure, tune and lock central wavelengths of lasers over a broad range.

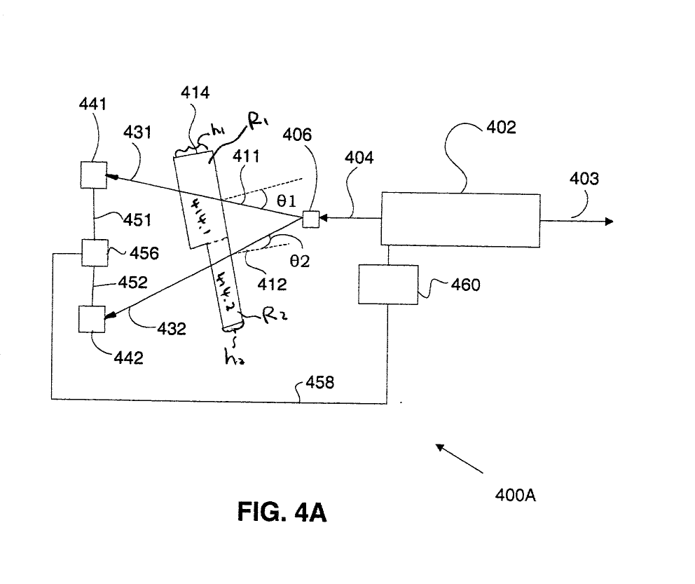

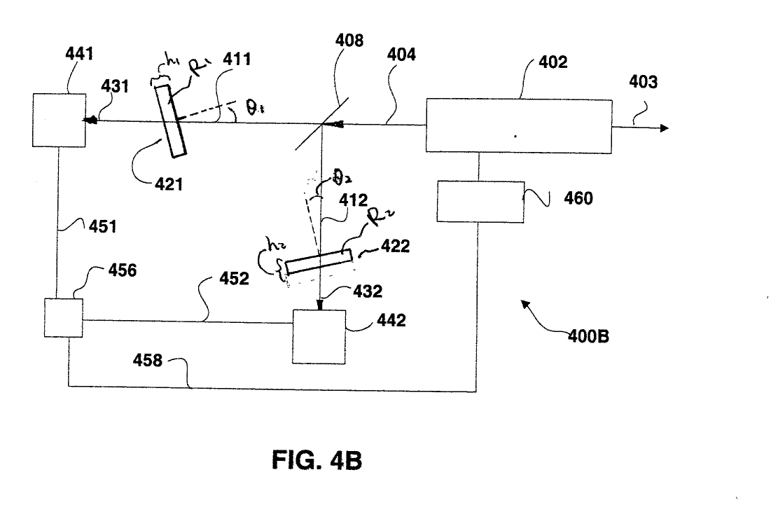

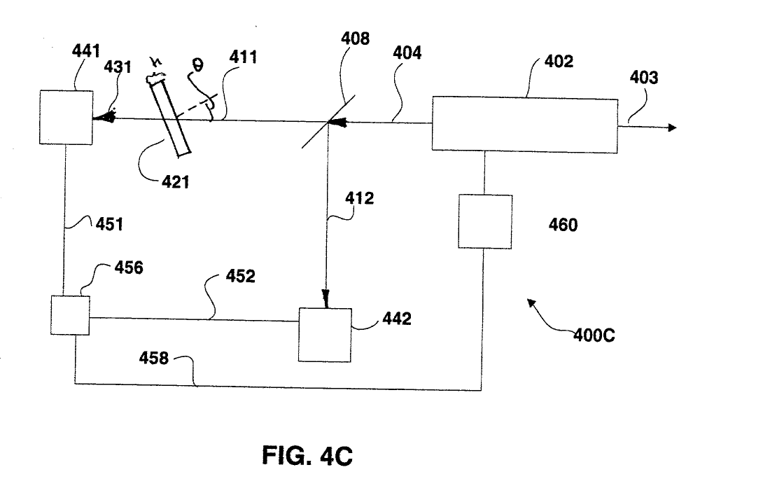

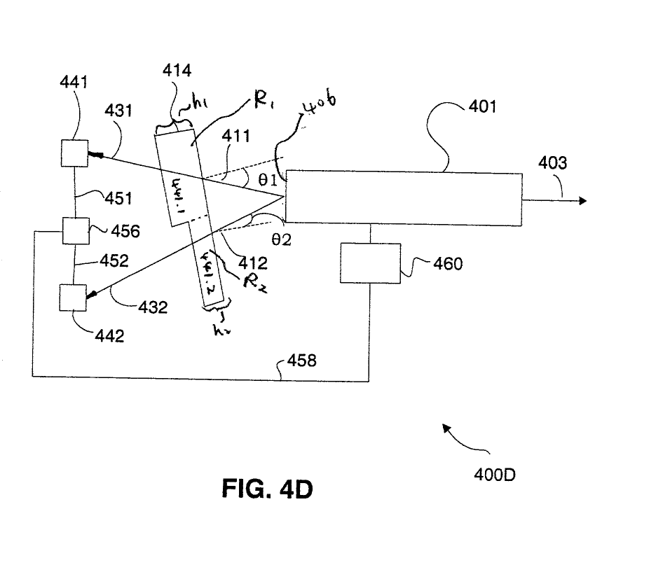

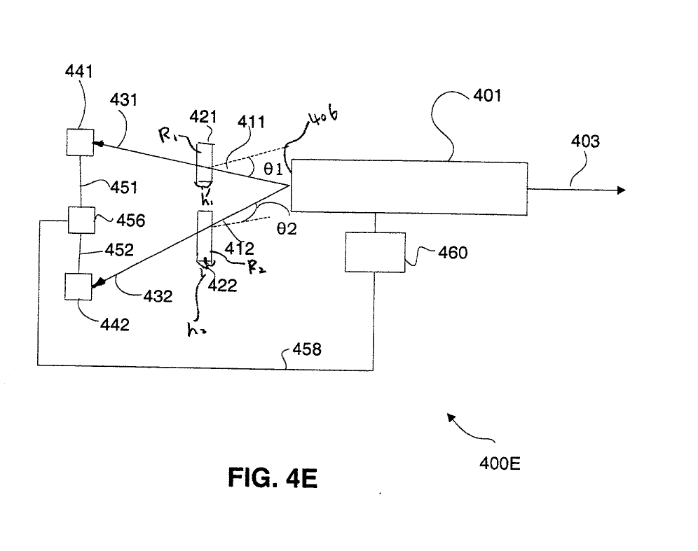

In describing the embodiments of the present invention shown in FIGS. 4A-4E, like components have been given the same numerical labels. FIG. 4A shows a laser wavelength locking system 400A, in accordance with a first embodiment of the present invention. The system 400A includes a laser emitter 402 (such as a laser diode), a refractive light splitter 406, an etalon substrate 414 having a first region 414_{·1} and a second region 414_{·2}, two photo-detectors 441 and 442, a processor unit 456, and a laser control unit 460. The laser diode 402 generates a front (or source) laser beam 403 and a rear laser beam 404. The front and rear laser beams have identical optical spectral characteristics. Thus, while the front laser beam 403 is utilized to modulate communication signals, the rear laser beam 404 is utilized to measure, tune and lock the central wavelength of the front laser beam 403. To that end, the rear laser beam 404 is delivered onto the diffractive light splitter 406, where the rear laser beam 404 is split into a first laser beam 411 and a second laser beam 412. The first region 414_{·1} of the etalon substrate 414 receives the first laser beam 411 at a first incident angle θ₁, and the second region 414_{·2} of the etalon substrate 414 receives the second laser beam 412 at a second incident angle θ₂. Because the first and second regions 414_{·1} and 414_{·2} of the etalon substrate 414 may have different thickness, h1 and h2; different reflection coefficients, R1 and R2; and different incident angles, θ₁ and θ₂; they have different wavelength filtering (or bandpass) characteristics. A fraction of the first laser beam 411 passes through the first region 414_{·1} of the etalon substrate 414 to form a first reference laser beam 431. Likewise, a fraction of the second laser beam 412 passes through the second region 414_{·2} of the etalon substrate 414 to form a second reference laser beam 432. The first and second reference laser beams 431 and 432 are delivered onto the first and second photo-detectors 441 and 442, respectively. The first photo-detector 431 generates a first reference photo-current in response to the light intensity of the first reference laser beam 431. Likewise, the second photo-detector 432 generates a second reference photo-current in response to the light intensity of the second reference laser beam 432. The first and second reference photo-currents are then coupled to the processing unit 456 through connections 451 and 452, respectively. The processing unit 456 calculates a current difference between the first and second reference photo-currents as a measurement of the central wavelength of the front (or source) laser beam 403. This measured wavelength is utilized to tune (or adjust) the central wavelength of the source laser beam 403. Specifically, the processing unit 456 contains a memory device to store a look-up table for storing wavelength values corresponding to respective current difference values. In addition, the processing unit 456 contains a memory device to store a targeted wavelength value. In response to a current difference, the processing unit 456 searches the look-up table to locate a wavelength measurement value. The processing unit 456 then compares the wavelength measurement value with the targeted wavelength value to obtain a wavelength adjustment value, which is coupled to the laser control unit 460 through the connection 458. Based on the wavelength adjustment value, the laser control unit 460 tunes the laser diode 402 to adjust the central wavelength of the source laser beam 403. By dynamically measuring and adjusting the central wavelength of the source laser beam 403, the source laser beam 403 is locked at a desired central wavelength. It should be noted that because the two filters (i.e., the first and second regions 414_{·1} and 414_{·2}) in this embodiment are deployed on one etalon substrate, these two filters can be conveniently installed without requiring alignment.

FIG. 4B shows a laser wavelength locking system 400B, in accordance with a second embodiment of the present invention. The system 400B has a similar structure as that in the system 400A except that the diffractive splitter 406 in the system 400A is replaced by a refractive splitter 408 in the system 400B. In addition, the etalon substrate 414 in the system 400A is replaced by first and second etalon filters 421 and 422. In operation, the laser diode 402 generates a front (source) laser beam 403 and a rear laser beam 404. The rear laser beam 404 is delivered onto the refractive splitter 408. The refractive splitter 408 performs 50%-50% splitting to split the rear laser beam 404 into a first laser beams 411 and a second laser beam 412. The first etalon filter 421 receives the first laser beam 411 at a first incident angle θ₁, and the second etalon filter 422 receives the second laser beam 412 at a second incident angle θ₂. Because the first and second etalon filters 421 and 422 may have different thickness, h1 and h2; different reflection coefficients, R1 and R2; and different incident angles, θ₁ and θ₂; they have different wavelength filtering (or bandpass) characteristics. A fraction of the first laser beam 411 passes through the first etalon filter 421 to form a first reference laser beam 431. Likewise, a fraction of the second laser beam 412 passes through the second etalon filter 422 to form a second reference laser beam 432. Upon receiving the first and second reference laser beams, the first and second etalon filters 421 and 422 generate first and second reference photo-currents, respectively. Upon receiving the first and second reference photo-currents, the processing unit 456 calculates a current difference between the first and second reference photo-currents and generates a wavelength adjustment value based on the current difference. Upon receiving the wavelength adjustment value, the laser control unit 460 tunes the laser diode 402 to adjust the central wavelength of the source laser beam 403. In the embodiment shown in FIG. 4B, one special case is that the first incident angle θ₁ is equal to the second incident angle θ₂. While the common-substrate filter approach shown in FIG. 4A facilitates filter installation without requiring alignment, the two-separate-filters approach shown in FIG. 4B provides flexibility and bandwidth scalability.

FIG. 4C shows a laser wavelength locking system 400C, in accordance with a third embodiment of the present invention. The system 400C has a similar structure as that in the system 400B except that the second etalon filter 422 in the system 400B is omitted in the system 400C. In operation, the laser diode 402 generates a front (source) laser beam 403 and a rear laser beam 404. The rear laser beam 404 is delivered onto the refractive splitter 408. The refractive splitter 408 performs 50%-50% splitting to split the rear laser beam 404 into a first laser beams 411 and a second laser beam 412. The etalon filter 421 receives the first laser beam 411 at an incident angle θ. A fraction of the first laser beam 411 passes through the etalon filter 421 to form a reference laser beam 431. Upon receiving the reference laser beam, the first photo-detector 441 generates a first reference photo-current. Upon receiving the second laser beam, the second photo-detector 442 generates a second reference photo-current. Upon receiving the first and second reference photo-currents, the processing unit 456 calculates a current difference between the first and second reference photo-currents and generates a wavelength adjustment value based on the current difference. Upon receiving the wavelength adjustment value, the laser control unit 460 tunes the laser diode 402 to adjust the central wavelength of the source laser beam 403.

FIG. 4D shows a laser wavelength locking system 400D, in accordance with a fourth embodiment of the present invention. The system 400D has a similar structure as that in the system 400A except that the refractive splitter 406 in the system 400A is omitted in the system 400D. In addition, the laser diode 402 in the system 400A is replaced by a laser diode 401 having a laser emitting side 406 in the system 400D. In operation, the laser diode 401 generates a front (or source) laser beam 403 and a rear laser beam (not shown). Using divergence effect, the laser emitting side 406 splits the rear laser beam into a first laser beams 411 and a second laser beam 412. In the system 400D, the etalon substrate 414, first and second photo-detectors 441 and 442, processing unit 456 and laser control unit 460 perform the same functions as described in connection with the system 400A of FIG. 4A.

FIG. 4E shows a laser wavelength locking system 400E, in accordance with a fifth embodiment of the present invention. The system 400E has a similar structure as that in the system 400D except that the etalon substrate 414 in the system 400D is replaced by a first and a second etalon filters 421 and 422 in the system 400E. In operation, the laser diode 401 generates a front (or source) laser beam 403 and a rear laser beam (not shown). Using divergence effect, the laser emitting side 406 splits the rear laser beam into a first laser beams 411 and a second laser beam 412. The first etalon filter 421 receives the first laser beam 411 at a first incident angle θ₁, and the second etalon filter 422 receives the second laser beam 412 at a second incident angle θ₂. A fraction of the first laser beam 411 passes through the first etalon filter 421 to form a first reference laser beam 431. Likewise, a fraction of the second laser beam 412 passes through the second etalon filter 422 to form a second reference laser beam 432. In the system 400D, the first and second photo-detectors 441 and 442, processing unit 456 and laser control unit 460 perform the same functions as described in connection with the system 400A of FIG. 4A.

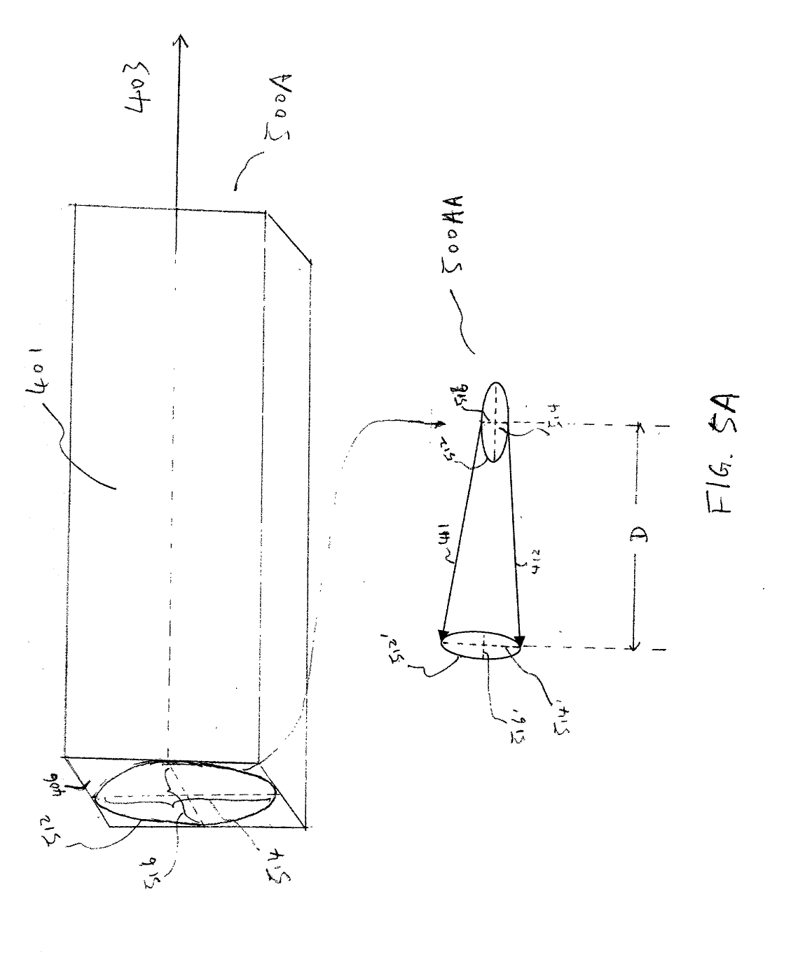

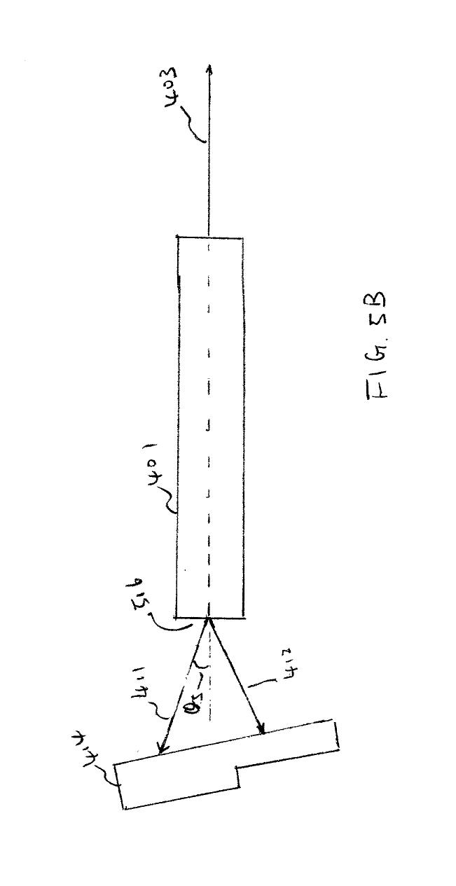

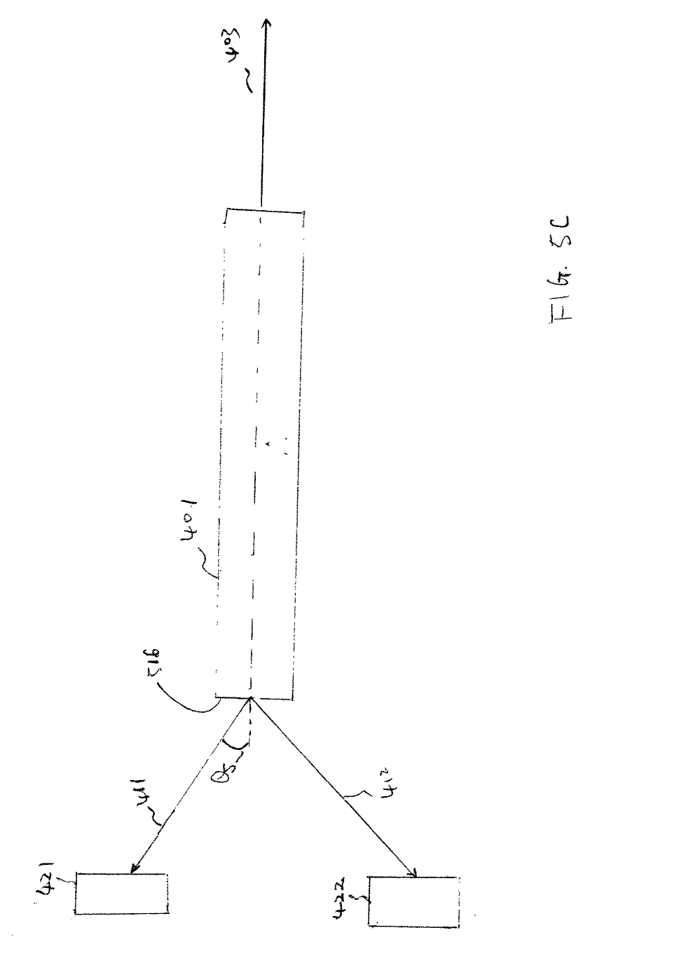

FIG. 5A shows the emitting side 406 of the diode 401 of FIGS. 4D-E in further detail. As shown in 500A, the emitting side 406 has an elliptical emitting boundary 512, which contains a major (or long) axis 514 and a minor (or short) axis 516. Based on laser light diffraction nature, the diffraction angle θₛ along the short axis of the emitting boundary 512 is much wider than the diffraction angle θ₁ along the long axis of the emitting boundary 512. As shown in 500AA, after projecting the first and second laser beams 411 and 412 from the emitting side 406 over a distance D, the dimension along the short axis 516 of the elliptical boundary 512 becomes the dimension along the long axis 514′ of the projected elliptical boundary 512′ at the distance D.

FIG. 5B shows a section view of the diode 401, cutting through the line A-A′ of FIG. 5A, in according to one embodiment of the present invention. In FIG. 5B, the rear laser beam (not shown) is split into the first laser beam 411 and the second laser beam 412 along the short axis 516 of the elliptical emitting boundary 516. The etalon substrate 414 is disposed along the short axis 516.

FIG. 5C shows a section view of the diode 401, cutting through the line A-A′ of FIG. 5A, in accordance with another embodiment of the present invention. In FIG. 5C, the rear laser beam (not shown) is split into the first laser beam 411 and the second laser beam 412 along the short axis 516 of the elliptical emitting boundary 512. The first and second etalon filters 421 and 422 are disposed along the short axis 516.

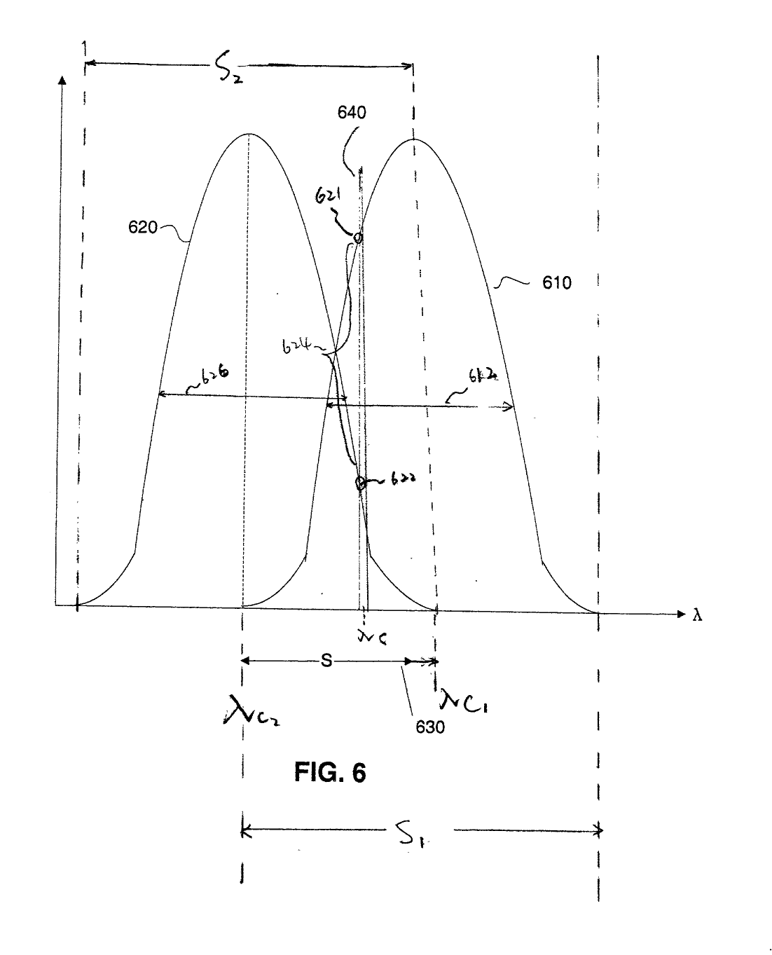

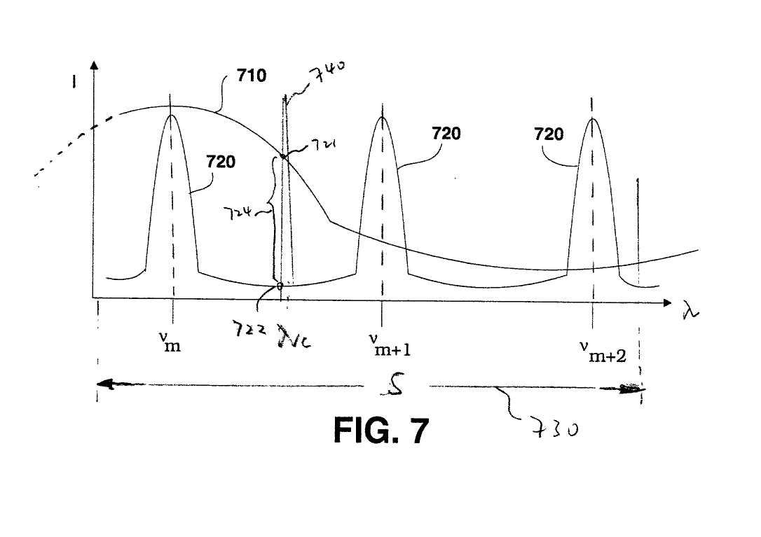

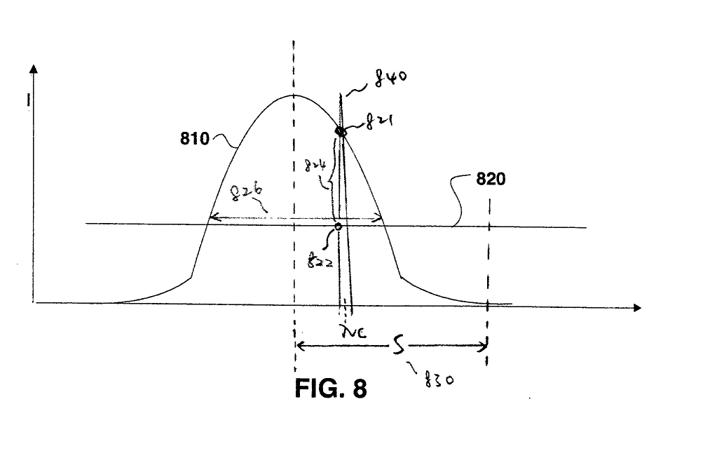

FIG. 6 shows two spectral photo-current curves (or two reference photo-current curves) observed from the first and second photo-detectors 441 and 442 shown in FIGS. 4A-B and 4D-E. Specifically, the first photo-detector 441 generates a first photo-current curve 610 in response to the first reference laser beam 431, and the second photo-detector 442 generates a second photo-current curve 620 in response to the second reference laser beam 432. Because of the wavelength filtering (or bandpass) characteristics of the filter 414_{·1} or 421, the first photo-current curve 610 changes its current value within a first wavelength region S1 having a central wavelength λc1. Likewise, because of the wavelength filtering (or bandpass) characteristics of the filter 414_{·2} or 422, the second photo-current curve 620 changes its current value within a second wavelength region S2 having a central wavelength λc2. The first wavelength region S1 overlaps with the second wavelength region S2 to form a common wavelength region S 630. Within the common wavelength region S 630, the first photo-current curve 610 can be used as a reference current to the second photo-current curve 620 and vice versa. By appropriately selecting (or setting) reflection coefficients, R1 and R2; thicknesses, h1 and h2; and incident angles, θ₁ and θ₂; the central wavelength λc of the source laser beam 403 can be tuned within the common wavelength region S 630. As shown in FIG. 6, at a given central wavelength λc, the rear laser beam of FIGS. 4A-B and 4D-E is observed as a photo-current curve 640 from both photo-detectors 441 and 442, which intersects the first and second photo-current curves within the common wavelength region S 630, resulting in a first current point value 621 on the first photo-current curve 610 and a second current point value 622 on the second photo-current curve 620. The current value difference 624 between the first and second current point values indicates the central wavelength of the source laser beam 403. In the present invention, any laser having a central wavelength λc within the common wavelength region S 630 can be measured and locked to meet various tuning and/or locking requirements. Therefore, the present invention can produce a broadband locking mechanism by using conventional etalon filters. Broadband locking means that a laser central wavelength can be locked at a specific wavelength point with minimum drift once locked, and the specific wavelength can be positioned at a very wide (or broad) spectrum/wavelength rang. To achieve this objective, the present invention tunes the shape (including half-width-at-half-maximum 612) of the first photo-current curve 610 by adjusting the R1 or h1 shown in FIGS. 4A-B and 4D-E. Likewise, the present invention tunes the shape (including half-width-at-half-maximum 626) of the second photo-current curve 620 by adjusting the R2 or h2 shown in FIGS. 4A-B and 4D-E. The location and spread of the common wavelength region S 630 can be tuned by adjusting incident angle θ₁ or θ₂ and thickness h1 or h2 shown in FIGS. 4A-B and 4D-E. This principle also applies to the photo-current curves shown in FIG. 7 or 8. In addition, because the first and second photo-current curves 610 and 620 change their current values in opposite directions within the common wavelength region S 630, the present invention can provide high sensitivity and accuracy to measure, tune and lock the central wavelength of the source laser beam 403 with a broad spectral/wavelength range.

FIG. 7 shows two spectral photo-current curves (or two reference photo-current curves) observed from the first and second photo-detectors 441 and 442 shown in FIGS. 4A-B and 4D-E, where the thickness h1 of the first etalon filter 421 (or the first region 441_{·1}) is much thinner than the thickness h2 of the second etalon filter 422 (or the second region 441_{·2}). Specifically, the first photo-detector 421 (or the first region 441_{·1}) generates a first photo-current curve 710 in response to the first reference laser beam 431 and the second photo-detector 422 (or the second region 441_{·2}) generates a second photo-current curve 720 in response to the second reference laser beam 432. Because the thickness h1 of the first etalon filter 421 (or the first region 441_{·1}) is much thinner than the thickness h2 of the second etalon filter 422 (or the second region 441_{·2}), the first photo-current curve 710 overlaps with three harmonic current peaks in the second photo-current curve 720 corresponding to three central wavelengths at vₘ, vₘ₊₁, and vₘ₊₂. Therefore, comparing with the embodiment shown in FIG. 6, this embodiment provides a wider common wavelength region S 730. As shown in FIG. 7, at a given central wavelength λc, the rear laser beam of FIGS. 4A-B and 4D-E is observed as a photo-current curve 740 from both photo-detectors 441 (or the first region 441_{·1}) and 442 (or the second region 441_{·2}) which intersects the first and second photo-current curves 710 and 720 within the common wavelength region 730, resulting in a first current point value 721 on the first photo-current curve 710 and a second current point value 722 on the second photo-current curve 720. The current value difference between the first and second point current values 721 and 722 indicates the central wavelength of the source laser beam 403.

FIG. 8 shows two spectral photo-current curves observed from the first and second photo-detectors 441 and 442 shown in FIG. 4C. Specifically, the first photo-detector 441 generates a first photo-current curve 810 in response to the reference laser beam 431 and the second photo-detector 442 generates a second photo-current curve 820 in response to the second laser beam 412. Because the second photo-detector 442 receives the second laser beam 412 without any filtering, the second current curve 820 becomes a flat line. The first photo-current curve 810 overlaps with the second photo-current curve to form a common wavelength region S 830, which occupies a half (the right half for example) span of the first photo-current curve 810. As show in FIG. 8, at a given central wavelength λc, the rear laser beam of FIG. 4C is observed as a photo-current curve 840 which intersects the current curves 810 and 820 within the common wavelength region S 830, resulting in a first current point value 821 on the first photo-current curve 810 and a second current point value 822 on the second photo-current curve 820. The current value difference between the first and second current values indicates the central wavelength of the source laser beam 403.

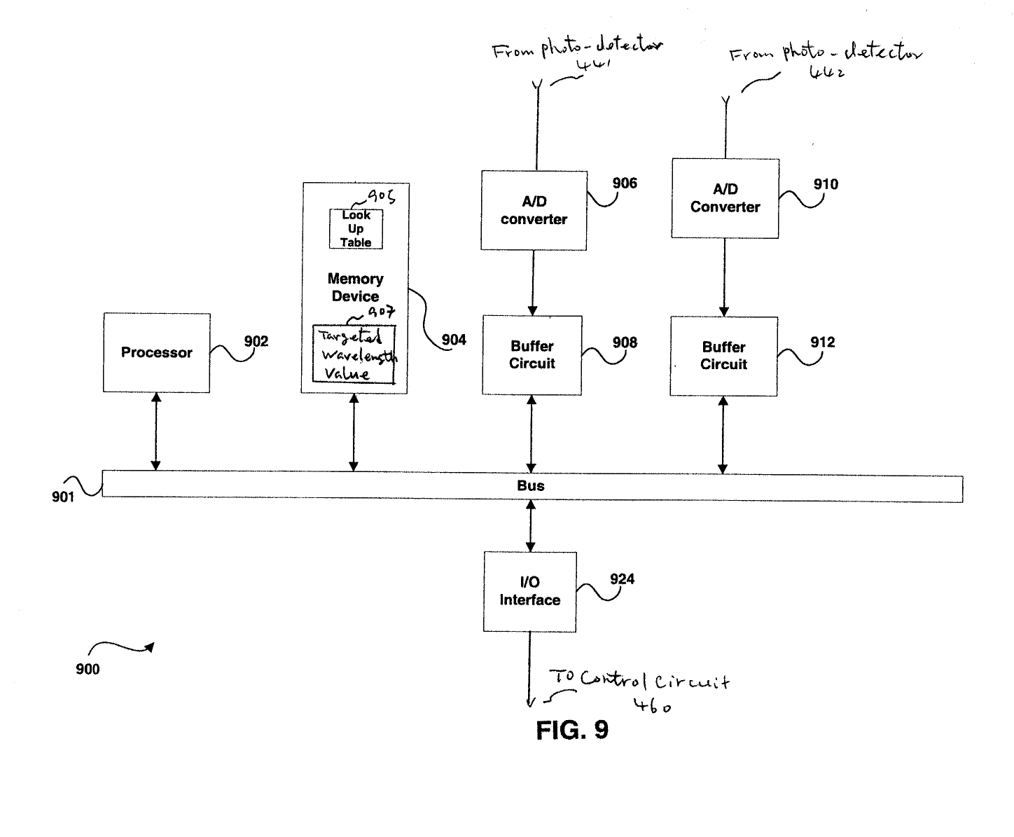

FIG. 9 is a block diagram of an exemplary processing unit 456 shown in FIGS. 4A-E in further detail, in accordance with the present invention. The processing unit 456 includes a processor 902, a memory device 904, a first analog-to-digital (A/D) converter 906, a first buffer circuit 908, a second analog-to-digital (A/D) converter 910, a second buffer circuit 912 and an I/O interface 924. All these components are coupled to a system bus 901. The memory device 904 can store programs including instructions and data. In particular, the memory device 904 stores a look-up table 905 and a targeted wavelength value 907. The first A/D converter 906 receives the first reference photo-current from the first photo-detector 441 and converter it into a first digitized current value. The second A/D converter 910 receives the second reference photo-current from the second photo-detector 442 and converter it into a second digitized current value. The first and second digitized current values are then stored in the first and second buffer circuits 908 and 912, respectively. The first or second buffer circuit can be a memory storage unit or a register. The I/O interface 924 can send data and control signals to the control circuit 460. The processor 902 has access to the memory device 904 and can control the operations of the processing unit 456 by executing the instructions stored in the memory device 904.

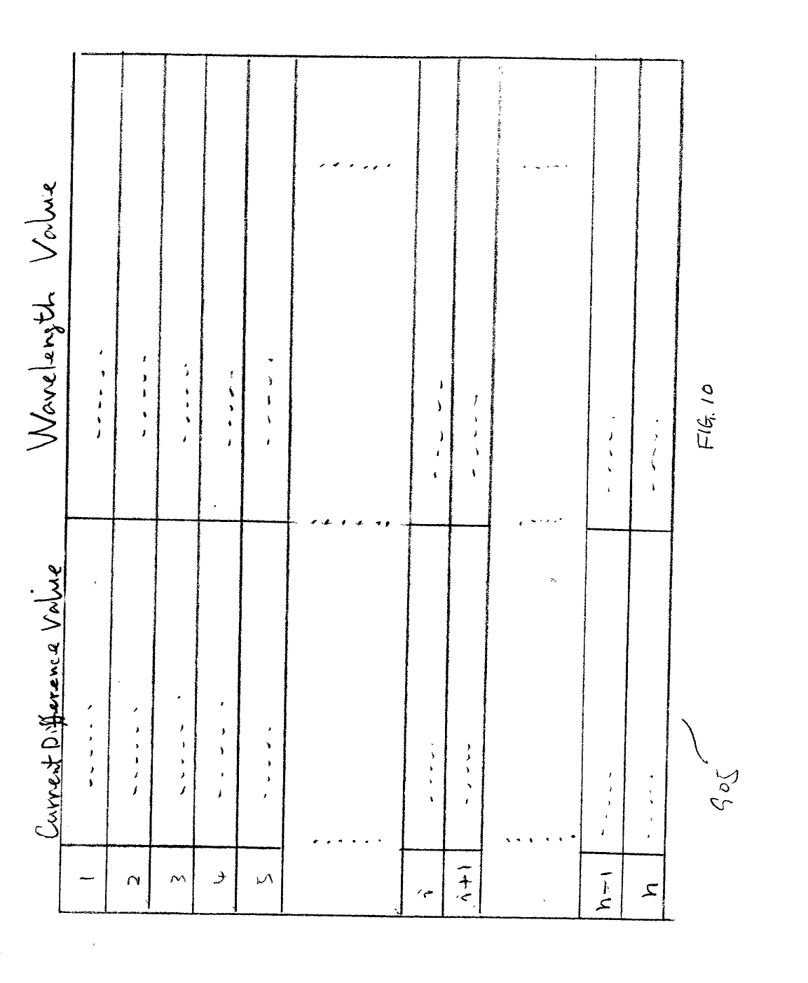

FIG. 10 shows the look-up table 905 of FIG. 9 in further detail. The look-up table 905 contains n entries. Each entry stores a current difference value and a corresponding wavelength value. The processor 902 calculates a current difference value based on the first and second digitized current values that are stored in the first and second buffer circuits 908 and 912, respectively. The processor 902 then locates an entry in the look-up table 905 containing a current difference value that matches or has the closest value to the calculated current difference value. The corresponding wavelength value stored in the located entry indicates the central wavelength of the source laser beam 403.

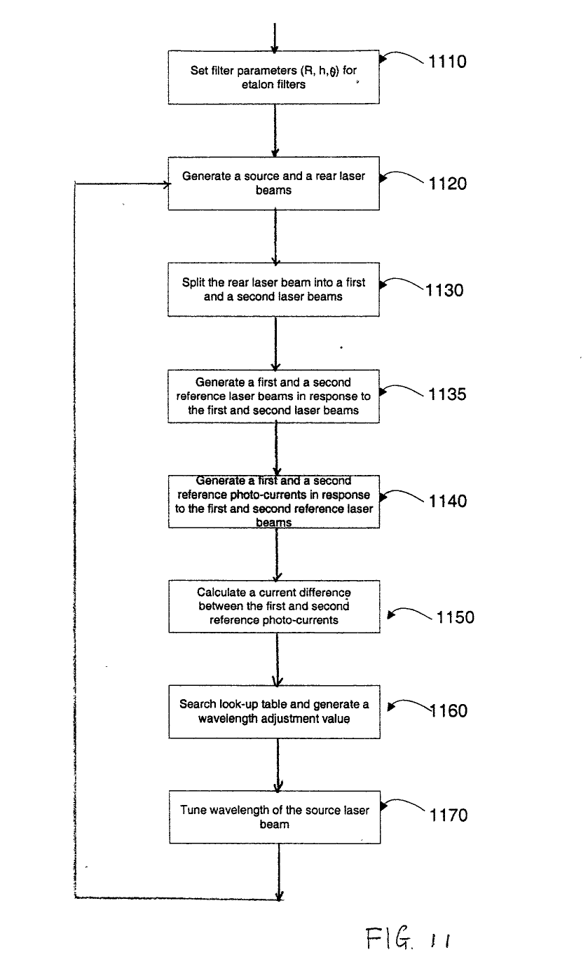

FIG. 11 is a flowchart illustrating an exemplary process of measuring, tuning and locking the wavelength of the source laser beam 403, in accordance with the present invention. In describing the process, it is assumed that the program for performing the steps of FIG. 11 has been stored in the memory device 904.

Step 1110 sets reflection coefficients R1 and R2; the thicknesses h1 and h2; and the incident angles, θ₁ and θ₂ for the etalon substrate 414 or etalon filters 421 and 422 to generate appropriate first and second reference photo-current curves as shown in FIGS. 6-8.

In step 1120, the laser diode 401 or 402 generates a front (or source) laser beam and a rear laser beam.

In step 1130, the diffractive splitter 406, the refractive splitter 408, or the laser diode 401 itself, splits the rear laser beam into a first laser beam and a second laser beam.

In step 1135, the etalon substrate 414 or the etalon filters 421 and 422 generate a first and a second reference laser beams in response to the first and second laser beams, respectively.

In step 1140, the first and second photo-detectors 441 and 442 generate a first and second reference photo-currents in response to the first and second reference laser beams, respectively. The first and second reference photo-currents are subsequently converted into a first and a second digitized current values by the first and second A/D converters 906 and 910, respectively. The first and second digitized current values are then stored in the first and second buffer circuits 908 and 912, respectively.

In step 1150, the processor 902 calculates a current difference between the first and second digitized current values.

In step 1160, the processor 902 searches the look-up table 905 to locate an entry containing a current difference value that matches or is closest to the calculated current difference value. The processor 902 then retrieves the wavelength value in the located entry and compares it with a targeted wavelength value to generate a wavelength adjustment value.

In step 1170, upon receiving the adjustment value, the laser control circuit 460 controls the laser diode 401 or 402 to adjust the central wavelength of the source laser beam 403. The process is then repeated through steps 1120 to 1170. By dynamically measuring and adjusting the central wavelength of the source laser beam 403, the source laser beam 403 is locked at a desired central wavelength.

Advantageously, the present invention provides a novel mechanism for measuring, tuning and locking central wavelengths of lasers over a broadband range (a range of 45 nm as an example, instead a range of 4 nm). The 45 nm range can cover entire C-band in the 1550 nm wavelength window. In addition, the novel locking mechanism uses a wide spectral look-up table containing multiple locking references, instead of using a single locking reference or a narrow band filter. This novel mechanism can be readily scaled into even larger wavelength ranges, such as S-band or L-band. Further, the present invention utilizes the rear laser beam to generate control signals to perform measuring, tuning and locking functions without inserting energy loss for the front laser beam which is utilized to modulate communication signals. With the foregoing features, the present invention provides a laser wavelength locking mechanism with the advantages of accuracy, low manufacturing cost, flexibility, scalability and small footprint.

While the invention has been illustrated and described in detail in the drawings and foregoing description, it should be understood that the invention may be implemented through alternative embodiments. Therefore, the scope of the invention is not intended to be limited to the illustration and description in this specification, but to be defined by the appended claims.

What is claimed is:

1. A device for measuring, tuning and locking the central wavelength of a laser beam that is split into a first laser beam and a second laser beam, comprising:
a filter substrate having a first region and a second region,
the first region receiving the first laser beam at a first incidence angle and generating a first reference laser beam in response to the first laser beam, and
the second region receiving the second laser beam at a second incidence angle and generating a second reference laser beam in response to second laser beam;
a first photo-detector for receiving the first reference laser beam, and for generating a first reference photo-current in response to the first reference laser beam; and
a second photo-detector for receiving the second reference laser beam, and for generating a second reference photo-current in response to the second reference laser beam, wherein a current difference between the first and second reference photo-currents indicates the central wavelength of the laser beam.

2. The device of claim 1, wherein the filter substrate is an etalon substrate.

3. The device of claim 1, further comprising:
a laser emitter for generating the laser beam, the divergence of the laser emitter splitting the laser beam into the first and second laser beams.

4. The device of claim 1, further comprising:
a refractive splitter for receiving the laser beam, and for splitting the laser beam into the first and second laser beams.

5. The device of claim 1, further comprising:
a processing unit, coupled to the first and second photo-detectors; and
a look-up table, coupled to the processing unit, for providing data to the processor unit to measure the central wavelength of the laser beam in response to the current difference of the first and second reference photo-currents.

6. The device of claim 5, further comprising:
a laser emitter for generating the laser beam; and
a control circuit, coupled to the laser emitter and the processing unit, for adjusting and locking the laser beam to a desired central wavelength.

7. The device of claim 1, wherein the laser beam is a rear laser beam.

8. The device of claim 7, wherein:
the first region of the filter substrate has a first reflection coefficient R1; and
the second region of the filter substrate has a second reflection coefficient R2.

9. The device of claim 7, wherein:
the first region of the filter substrate has a first thickness h1; and
the second region of the filter substrate has a second thickness h2.

10. The device of claim 1, wherein:
the first and second reference photo-currents overlap over a common wavelength region within which the current difference of the first and second reference photo-currents is utilized to measure the central wavelength of the laser beam.

11. The device of claim 10, wherein:
the first and second reference photo-currents change their values in opposite directions within the common wavelength region.

12. The device of claim 10, wherein:
the common wavelength region can be tuned by adjusting the first or second incident angle and thickness of the first or second region of the filter substrate.

13. A device for measuring, tuning and locking the wavelength of a laser beam that is split into a first laser beam and a second laser beam, comprising:
a first filter for receiving the first laser beam at a first incidence angle, and for generating a first reference laser beam in response to the first laser beam;
a second filter for receiving the second laser beam at a second incidence angle, and for generating a second reference laser beam in response to the second laser beam;
a first photo-detector for receiving the first reference laser beam, and for generating a first reference photo-current in response to the first reference laser beam; and
a second photo-detector for receiving the second reference laser beam, and for generating a second reference photo-current in response to the second reference laser beam, wherein a current difference between the first and second reference currents indicates the central wavelength of the laser beam.

14. The device of claim 13, wherein the first or second filer is an etalon filter.

15. The device of claim 13, further comprising:
a reflective splitter for receiving the laser beam, and for splitting the source laser beam into the first laser beam and the second laser beam.

16. The device of claim 13, further comprising:
a processing unit, coupled to the first and second photo-detectors; and
a look-up table, coupled to the processing unit, for providing data to the processor unit to measure the central wavelength of the laser beam in response to the current difference of the first and second reference currents.

17. The device of claim 16, further comprising:
a laser emitter for generating the laser beam; and
a control circuit, coupled to the laser emitter and the processing unit, for adjusting and locking the laser beam to a desired central wavelength.

18. The device of claim 13, wherein the laser beam is a rear laser beam.

19. The device of claim 18, wherein:
the first filter has a first reflection coefficient R1; and
the second filter has a second reflection coefficient R2.

20. The device of claim 18, wherein:
the first filter has a first thickness h1; and
the second filter has a second thickness h2.

21. The device of claim 18, wherein:
the first and second reference photo-currents overlap over a common wavelength region within which the current difference of the first and second reference photo-currents is utilized to measure the central wavelength of the laser beam.

22. The device of claim 21, wherein:
the first and second reference photo-currents change their values in opposite directions within the common wavelength region.

23. The device of claim 21, wherein:
the common wavelength region of the first and second reference currents can be tuned by adjusting the first or second incident angle and thickness of the first or second filter.

24. The device of claim 13, wherein:
the first filter includes a first etalon substrate having a first thickness h1;
the second filter includes a second etalon substrate having a second thickness h2; and
the first thickness h1 is much thinner than the second thickness h2.

25. The device of calm 24, wherein the first incident angle is equal to the second incident angle.

26. A device for measuring, tuning and locking the wavelength of a laser beam that is split into to a first laser beam and a second laser beam, comprising:
a filter for receiving the first laser beam at a first incidence angle, and for generating a reference laser beam in response to the first laser beam;
a first photo-detector for receiving the reference laser beam, and for generating a first reference photo-current in response to the reference laser beam; and
a second photo-detector for receiving the second laser beam without using a filter, and for generating a second reference photo-current in response to the second laser beam, wherein a current difference between the first and second reference photo-currents indicates the central wavelength of the laser beam.

27. The device of claim 26, further comprising:
a reflective splitter for receiving the laser beam, and for splitting the laser beam into the first laser beam and the second laser beam.

28. The device of claim 26, further comprising:
a processing unit, coupled to the first and second photo-detectors; and
a look-up table, coupled to the processing unit, for providing data to the processor unit to measure the central wavelength of the laser beam in response to the current difference of the first and second reference photo-currents.

29. The device of claim 28, further comprising:
a laser emitter for generating the laser beam; and
a control circuit, coupled to the laser emitter and the processing unit, for adjusting and locking the laser beam to a desired central wavelength.

30. The device of claim 26, wherein the laser beam is a rear laser beam.

31. The device of claim 30, wherein:
the filter has a reflection coefficient R.

32. The device of claim 30, wherein:
the filter has a thickness h.

33. The device of claim 26, wherein:
the first and second reference currents overlap over a common wavelength within which the current difference of the first and second reference photo-current is utilized to measure the central wavelength of the laser beam.

34. A device for measuring, tuning and locking laser wavelengths, comprising:
a laser emitter for generating a laser beam, the laser emitter including a laser emitting side having an elliptical emitting boundary that has a short axis and a long axis, wherein the divergence of the laser beam along short axis of the elliptical emitting boundary splits the source beam into a first laser beam and a second laser beam;
a first filter for receiving the first laser beam at a first incidence angle, and for generating a first reference laser beam in response to the first laser beam;
a second filter for receiving the second laser beam at a second incidence angle, and for generating a second reference laser beam in response to the second laser beam, wherein the first and second filters are deployed along the short axis of the elliptical emitting boundary;
a first photo-detector for receiving the first reference laser beam, and for generating a first reference photo-current in response to the first reference laser beam; and
a second photo-detector for receiving the second reference laser beam, and for generating a second reference photo-current in response to the second reference laser beam, wherein a current difference between the first and second reference photo-currents indicates the central wavelength of the laser beam.

35. The device of claim 34, wherein the first or second filer is an etalon filter.

36. The device of claim 34, further comprising:
a reflective splitter for receiving the laser beam, and for splitting the laser beam into the first laser beam and the second laser beam.

37. The device of claim 34, further comprising:
a processing unit, coupled to the first and second photo-detectors; and
a look-up table, coupled to the processing unit, for providing data to the processor unit to measure the central wavelength of the laser beam in response to the current difference of the first and second reference photo-currents.

38. The device of claim 37, further comprising:
a control circuit, coupled to the laser emitter and the processing unit, for adjusting and locking the laser beam to a desired central wavelength.

39. The device of claim 34, wherein the laser beam is a rear laser beam.

40. The device of claim 39, wherein:
the first filter has a first reflection coefficient R1; and
the second filter has a second reflection coefficient R2.

41. The device of claim 39, wherein:
the first filter has a first thickness h1; and
the second filter has a second thickness h2.

42. The device of claim 39, wherein:
the first and second reference photo-currents overlap over a common wavelength region within which the current difference of the first and second reference photo-current is utilized to measure the central wavelength of the laser beam.

43. The device of claim 42, wherein:
the first and second reference currents change their values in opposite directions within the common wavelength region.

44. The device of claim 42, wherein:
the common wavelength region of the first and second reference photo-currents can be tuned by adjusting the first or second incident angle and thickness of the first or second filter.

45. The device of claim 44, wherein:
the first filter includes a first etalon substrate having a first thickness h1; and
the second filter includes a second etalon substrate having a second thickness h2.

46. The device of claim 34, wherein the incidence angle along the short axis is wider then the incidence angle along the long axis.

47. A method for measuring, tuning and locking laser wavelengths, comprising the steps of:
splitting a laser beam into a first and a second laser beams;
generating a first reference laser beam in response to the first laser beam;
generating a second reference laser beam in response the second laser beam;
generating a first reference photo-current in response to the first reference laser beam;
generating a second reference photo-current in response to the second reference laser beam; and
generating a current difference between the first and second reference photo-currents to measure a central wavelength of the laser beam.

48. The method of claim 47, further comprising the step of:
tuning the central wavelength of the laser beam in response to the current difference.
